(19) United States
(12) Patent Application Publication
(10) Pub. No.: US 2010/0051600 A1
(43) Pub. Date: Mar. 4, 2010

(54) COMBINATION STEAMER

(76) Inventor: Max Maier, Ludwigsburg (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/204,191

(22) Filed: Sep. 4, 2008

(51) Int. Cl. A47J 27/16

(52) U.S. Cl. 219/401; 126/20; 99/331

(57) ABSTRACT

A combination steamer is described that has a cooking chamber which is externally delimited by a floor, walls, and a door. A steam generator and a first heater disposed on at least one of the walls are assigned to the cooking chamber. The floor is provided with a second heater. Both heaters are disposed outside the cooking chamber. The floor is formed as a cook top provided with the second heater. The walls are each in the form of a heating panel provided with a first heater. The cook top is retractable from the cooking chamber in the manner of a drawer. Thus food can be cooked on the cook top when the cook top is either inside or outside the cooking chamber.

### BACKGROUND OF THE INVENTION

1. Field of the Invention

The invention relates to a combination steamer comprising a cooking chamber externally delimited by a floor, walls, and a front door, and having a steam generator, and a first heater disposed on at least one of the walls and a second heater disposed on the floor.

2. Description of Related Art

A known combination steamer of this type (DE 201 05 820 U1) is designed for cooking by means of hot air and/or steam. In general, combination steamers are a combination of a steam cooker and an oven. They are used either for baking or for steam cooking. Food to be cooked can be simply steamed while at, say, 100° C. water is repeatedly injected. In the known combination steamer, this injected water is vaporized by the first heater. The first heater, which is mounted on the inside surface of a wall of the cooking chamber, comprises a fan adapted to circulate the generated steam in the cooking chamber. Since, in general, direct heating of the food to be cooked is hardly feasible in a combination steamer, certain foods, such as pizza, tarte flambee, vegetable quiches and the like, cannot be cooked in a combination steamer with satisfactory results. The known combination steamer is therefore equipped such that even pizza and the like can be cooked to satisfaction. For this purpose, the known combination steamer has a refractory stone, which can be moved into the cooking chamber to be heated by a second heater disposed in the cooking chamber. Furthermore, the cooking chamber in the known combination steamer is separated by an air baffle from a fan chamber in which the first heater and the fan are located. The cooking chamber of the known combination steamer therefore contains many obstructions which restrict or hamper the process of loading the cooking chamber and make it difficult to clean the latter. Furthermore, the second heater used in the known combination steamer for heating the refractory stone is not able to solve the problem relating to the inability to sear foods to be cooked in the combination steamer. When a combination steamer is employed in the food and catering industry, foods to be cooked can be dry-heated, supposedly corresponding to sautéing the food in a pan, but a liquid must subsequently be added and the food heated at a higher temperature of, say, 200° or 250° C. During this process, a large quantity of expelled vapors is produced, which must be removed with the exhaust air or which escapes when the door of the combination steamer is opened and must then be extracted by suction. For this purpose, there already exists a combination of an exhauster hood and a combination steamer, which is the subject matter of WO 2007/042307, which is not pre-published. It would be advantageous if meat could be sauteed in a combination steamer before being steam cooked. But to the applicant's knowledge, no combination steamer has as yet been disclosed that is suitable for this purpose.

A known oven (DE 36 02 398 A1) comprises a heater disposed in the baking chamber. Said heater likewise forms an obstacle in the baking chamber and is merely provided to heat a baking stone by radiant heat. This known oven therefore aims at solving a similar problem to that involved in the case of the known combination steamer mentioned above, namely that of making it possible to bake pizza and the like.

### BRIEF SUMMARY OF THE INVENTION

It is an object of the present invention to overcome the drawbacks of the prior art described above and to substantially expand the field of application of the combination steamer.

This object is achieved by the present invention with a combination steamer of the kind referred to at the outset in which both heaters are disposed outside the cooking chamber and the floor is designed as a cook top provided with the second heater.

In the combination steamer of the invention, both heaters are disposed outside the cooking chamber and thus do not form any obstacles inside the cooking chamber. The fact that the floor is designed as a cook top makes it possible to place a pan containing food to be sauteed on the cook top. After the sauteing process, the cook top can be switched off and the combination steamer then operated as a low-temperature cooker for slow cooking of the food or as a high-temperature cooker for fast cooking of the sauteed food. For completion of the cooking process, the pan containing the sauteed food can be placed on an insertable tray at a distance above the cook top in the cooking chamber so that the cook top can be used for heating the cooking chamber following sauteing, instead of being switched off. The pan can be a gastro-norm receptacle made of a multilayered material and located on slide rails above the floor. It should be noted that “Gastro-norm” corresponds to the European Standard EN 631 for catering containers. Furthermore, the steam generator can be switched on, in order to assist the process of steam cooking the food. Unlike the known combination steamer described at the outset, there is no need to have a fan in the cooking chamber of the combination steamer of the invention, since the heat rising from the switched-on cook top produces sufficient convective flow within the cooking chamber. There is thus no obstacle in the form of a fan in the cooking chamber of the combination steamer of the invention.

However, this does not rule out the possibility of providing a fan outside the cooking chamber and allowing its pressure side to communicate with the cooking chamber. This also applies to the steam generator, which, like the fan, is disposed outside the cooking chamber such that its steam outlet can communicate with the cooking chamber.

One main advantage of the combination steamer of the invention is that it can be used not only as a combination steamer and/or oven, but also as a stove and/or grill plate, since the floor of the cooking chamber of the combination steamer can be used as the cook top of a stove for cooking food. Thus the combination steamer of the invention has substantially more possible fields of application than the prior art.

Preferred embodiments of the invention form the subject-matter of the subclaims.

In one embodiment of the combination steamer of the invention, the cook top can be retracted from the cooking chamber in the manner of a drawer, so that the additional possible implementation of the cook top as a stove can be more readily realized. By opening the door and pulling out the cook top, the combination steamer can be instantly converted to a fully functioning stove. Moreover, this feature disposes with the need for a separate oven, a separate steam cooker, and a separate cook top in the kitchen and is a particularly interesting option for a one-person household, for example.

In another embodiment of the combination steamer of the invention, the cook top is a Ceran® (i.e., glass-ceramics) cook top or the like, so that the floor of the cooking chamber of the combination steamer can be readily implemented with a commercially available cook top.

In another embodiment of the combination steamer of the invention, the cook top comprises a plate made of metallic multilayered material, which offers additional advantages over the design of the cook top as a glass-ceramics cook top or the like. The metallic multilayered plate, which can have an architecture resembling that of a known multipurpose worktop for a stove or grill (DE 202 15 979 U1) or a known inductive grill plate (DE 101 20 500 B4) can itself be heated so that it can serve as a source of heat for the cooking chamber, unlike a glass-ceramics cook top, which does not increase its temperature during operation of the second heater, but instead allows heat radiated from a radiant heater to enter into the cooking chamber. The metallic multilayered material of the plate forming the cook top can itself be heated by a source of radiant heat or by an inductive heater and can thus serve as a source of heat. In addition, the plate made of metallic multilayered material can be used as a grill plate.

In another embodiment of the combination steamer of the invention, the second heater is a radiant and/or inductive heater, so that the second heater can be selected to suit the desired application of the cook top forming the floor of the cooking chamber. If, for example, a glass-ceramics cook top having an inductive heater were provided, then it would only be possible to heat a cooking appliance capable of induction and standing on the cook top. If the glass-ceramics cook top is additionally intended to serve as a source of heat for the cooking chamber, the second heater should be in the form of a radiant and inductive heater. If, on the other hand, the cook top forming the floor of the cooking chamber comprises a plate of multilayered material, then the second heater could be a radiant or inductive heater. A second heater designed as a radiant and inductive heater would be equally effective.

In another embodiment of the combination steamer of the invention, the cook top comprises a plurality of hot plates and the second heater comprises a plurality of heating means assigned individually to the hot plates, so that the cook top forming the floor of the cooking chamber offers the possibility of being used as a stove on which a plurality of cooking appliances can be used simultaneously for cooking purposes. In an advantageous variant of this embodiment of the invention the cook top is adapted to be retracted from the cooking chamber in the manner of a drawer. If the cook top comprises a plate made of glass-ceramics or metallic multilayered material, it is possible to use cooking appliances that are advantageously likewise made of a multilayered material capable of induction. A multilayered receptacle suitable for this purpose is known in the prior art (WO 2006/072459). The use of this known receptacle made of metallic multilayered material may be particularly advantageous when it is designed as a gastro-norm receptacle. One advantage of the embodiment of the combination steamer in which the cook top comprises a plurality of hot plates is that a plurality of foods can be simultaneously sauteed or, in general, preheated for cooking and can then be jointly cooked through in the combination steamer, which is then operated as an oven and/or steam cooker.

In another embodiment of the combination steamer of the invention, the cooking chamber comprises a discharge port for the exhaust steam and exhaust air, so that the combination steamer of the invention can be advantageously combined with an exhauster hood, as is the subject-matter of WO 2007/042307 cited above. The combination steamer of the invention provided with such an exhauster hood can then also be used to particular advantage as a stove, especially in the case of a cook top that can be retracted from the cooking chamber in the manner of a drawer, since expelled vapors resulting from cooking food can then be extracted by suction via said discharge port for exhaust steam and exhaust air into the exhauster hood, where they are cleaned and subsequently recycled to the immediate environment of the combination steamer. A combination steamer of this type in the form of an air circulation system can be set up in the center of the room, which makes possible another advantageous embodiment of the combination steamer of the invention in which an exhauster hood is located on top of the combination steamer and is connected to the discharge port thereof for exhaust steam and exhaust air.

If no exhauster hood is connected to the discharge port for exhaust steam and exhaust air of the cooking chamber, the said discharge port can lead to the open air, but this is less advantageous, from the point of view of energy conservation, than a solution based on circulated air, since in the latter case the air is cleaned only and need not be reheated.

In another embodiment of the combination steamer of the invention, at least one of the walls is in the form of a heating panel provided with a first heater, so that the convective flow produced from the floor with the aid of the cook top can be intensified and the cooking chamber can be heated to a suitable temperature more easily and more rapidly. For this purpose, each of at least one or two side walls is in the form of a heating panel provided with a first heater. In addition, or in lieu thereof, the top wall of the cooking chamber can be designed as a heating panel provided with a first heater. This offers the additional advantage that this heating panel can be used as a grill, thus disposing of the need for an additional grill rod such as can normally be inserted into an oven via a corresponding socket in the rear wall of the oven. This has the additional advantage that the combination steamer of the invention provides the possibility of grilling without involving any obstructions in the cooking chamber such as an additional insertable grill rod or the socket therefor. Thus in the combination steamer of the invention, the cooking chamber has perfectly smooth inside surfaces on all sides and yet provides all options offered by a known combination steamer and additionally the option of using the cook top in the floor of the combination steamer as a cook top or stovetop.

In another embodiment of the combination steamer of the invention, the heating panel comprises a plate made of glass-ceramics or the like or of a metallic multilayered material, so that it is possible, as explained above in the context of the second heater, to ideally select the first heater assigned to the heating panel to suit the intended application.

In another embodiment of the combination steamer of the invention, a fan is disposed outside the cooking chamber and communicates with the cooking chamber on its suction and pressure sides via openings in one of the walls, so that this fan intensifies, when necessary, the convective circulation of air and/or steam in the cooking chamber. Since the fan communicates with the cooking chamber on its suction and pressure sides merely via openings in one of the walls, while being disposed entirely outside the cooking chamber, it cannot form any obstruction in the cooking chamber. Unlike the prior art according to the above-cited DE 201 05 820 U1, the fan chamber in the cooking chamber need not be partitioned off from the remaining cooking chamber by an air baffle. Also, the use of a fan in the aforementioned embodiment of the invention thus leaves the interior of the cooking chamber free from obstructions.

This also holds true in another embodiment of the combination steamer of the invention, in which the steam generator is disposed outside the cooking chamber and communicates with the cooking chamber via its steam outlet side, because in this case also, the interior of the cooking chamber remains free from obstructions.

In another embodiment of the combination steamer of the invention, at least one ferromagnetic layer, the Curie temperature of which can be used for temperature control, is rolled into or onto the metallic multilayered material, so that it is possible to make advantageous use of the effect according to which heat energy above the Curie temperature destroys ferromagnetism and the ferromagnetic material shows paramagnetic behavior. This is manifested in the inability of the ferromagnetic material to be magnetic above this temperature and thus in the inability of the multilayered material to be overheated. This provides temperature control in the cooking chamber by way of the multilayered material. This feature can be further utilized by providing the plate made of multilayered material with a depression filled with water to act as steam generator.

### BRIEF DESCRIPTION OF SEVERAL VIEWS OF THE DRAWINGS

The invention will be described in conjunction with the following drawings in which like reference numerals designate like elements and wherein:

FIG. 1 is a lateral cross-sectional view of a first embodiment of a combination steamer of the invention;

FIG. 2 is a lateral cross-sectional view of a second embodiment of the combination steamer of the invention;

FIG. 3 is a lateral cross-sectional view of a third embodiment of the combination steamer of the invention; and

FIG. 4 is a front view of the combination steamer shown in FIG. 3, in which the door of the cooking chamber is not shown for the sake of clarity.

### DETAILED DESCRIPTION OF THE INVENTION

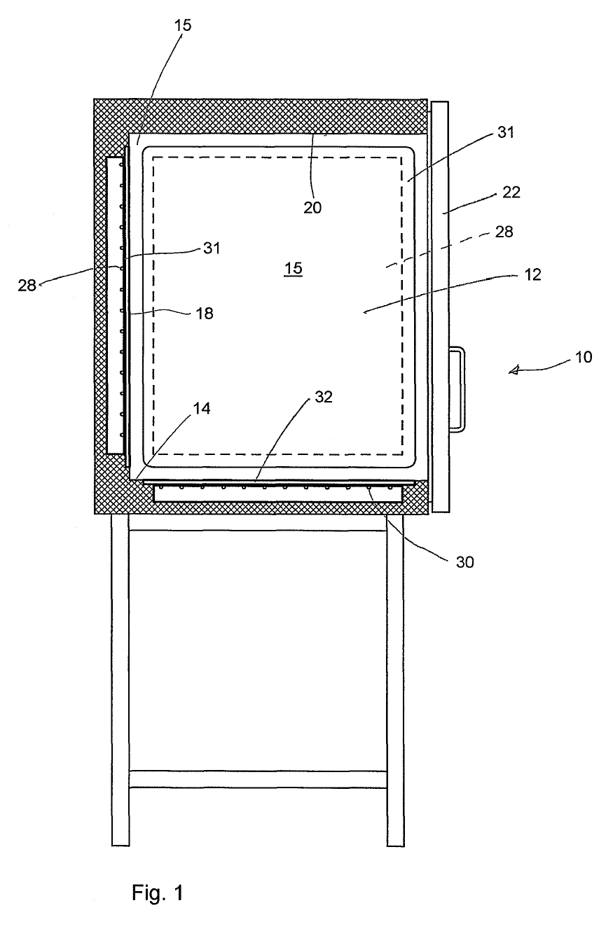

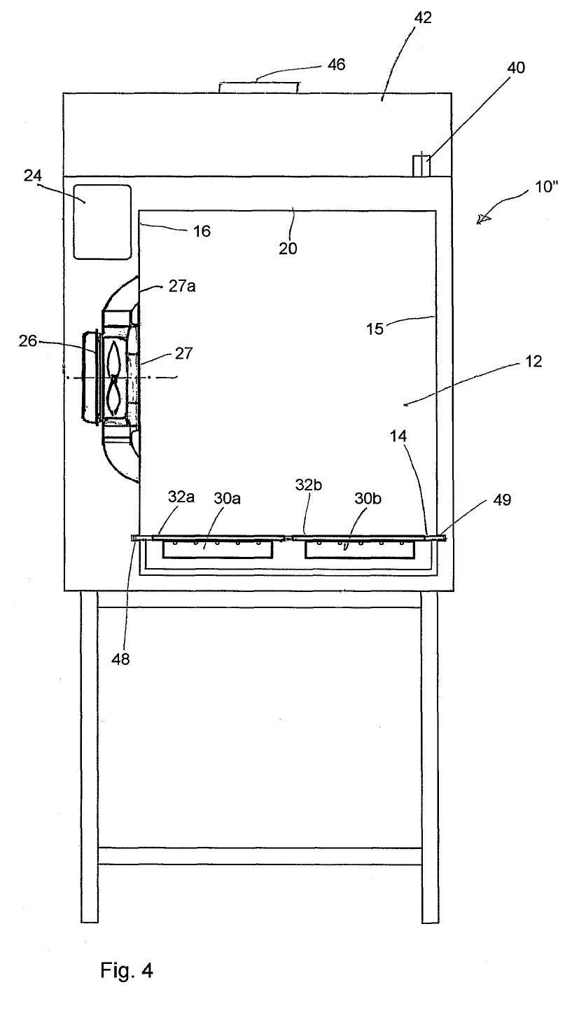

FIG. 1 shows a first embodiment of a combination steamer of the invention, which is designated as a whole by reference numeral 10. The combination steamer 10 in the first embodiment and in the embodiments described below is a so-called combination steamer, that is to say, a combination of a steam cooker and an oven. The combination steamer 10 has a cooking chamber 12, which is externally delimited by a floor 14, two side walls 15 and 16 (the latter is only visible in the view shown in FIG. 4), a rear wall 18, a top wall 20, and a front door 22. A steam generator 24 and an optional fan 26 are visible only in FIG. 4 and are therefore described in detail in connection with the third embodiment of the combination steamer 10″ shown in FIG. 4. Unlike a combination steamer known in the prior art described above, in which the floor 14 is usually a continuous one on which a second heater is disposed inside the cooking chamber, for example, for baking a pizza, the floor 14 of the combination steamer 10 described here is in the form of a cook top 32 provided with the second heater designated here by reference numeral 30. More precisely, in the first embodiment of the combination steamer 10 of the invention described here, the cook top 32 is embedded in the floor 14. The cook top 32 thus substantially forms the floor and performs its function of delimiting the cooking chamber 12 at the bottom. Furthermore, food present in a cooking appliance (not shown) can be cooked on the cook top 32 as on a conventional stove. Thus, for example, meat can be seared, this not being possible in a steamer using steam. The second heater 30, which is indicated here symbolically only and can be a radiant heater, for example a heating element, or an inductive heater, such as an induction coil, is located below the cook top 32 and thus outside the cooking chamber 12. If the cook top 32 is a glass-ceramics cook top or the like, the second heater 30 is designed as a radiant and/or inductive heater. The floor of the combination steamer 10 is shown in FIG. 1 as a heat-insulating wall in which the cook top 32 is embedded together with the second heater 30. The other walls are likewise heat-insulating.

The two opposing side walls 15 and 16 and the rear wall 18 (as mentioned above, the side wall 16 is not visible in FIG. 1 and is shown in FIG. 4) in the first embodiment of the combination steamer 10 have the same architecture as the floor 14 and are each formed as heating panels 31 provided with a first heater 28. A fourth side wall is not present but is instead formed by an opening offering access to the cooking chamber 12, which opening can be closed by means of the door 22. Unlike the prior art described above, the side walls 15, 16, and the rear wall 18 are also continuous walls, and the first heater is disposed behind these walls, that is to say, outside the cooking chamber 12. Each of the heating panels 31 is composed of a plate made of glass-ceramics or the like or of a metallic multilayered material and is embedded in the wall and performs the function of delimiting the cooking chamber laterally whilst making it possible to heat the cooking chamber without any need for the first heater to be disposed inside the cooking chamber. The metallic multilayered material, of which the plate of the cook top 32 or the plate of each heating panel 31 is made, is known in the prior art described at the outset. A multilayered material of such a type usually consists of a thick intermediate layer made of a thermally conductive material such as aluminum between two substantially thinner covering layers of stainless steel. One of the two covering layers can be made of ferritic steel, that is, a magnetizable material. The other covering layer can be made of austenitic steel, that is, a non-magnetizable material. One or both covering layers can be made of ferromagnetic steel.

The cook top 32 can comprise a plurality of hot plates (designated by reference numerals 32a and 32b in FIG. 4). In this case, the second heater 30 comprises a plurality of heating means (designated by reference numerals 30a and 30b in FIG. 4), individually assigned to each of the hot plates. In this case, the combination steamer can first be used as a stove when the door 22 is open (the heating panels 31 being switched off). Then the door 22 can be closed and the combination steamer 10 operated as an oven and/or a steam cooker, in which case the heating panels 31 and the steam generator 24 (not shown in FIG. 1) are switched on.

In the combination steamer 10 shown in FIG. 1, the heat rising from the cook top 32 and from the heating panels 31 produces sufficient convection flow within the cooking chamber 12 to make it possible to dispense with a fan 26, as is required in the cooking chamber of a combination steamer known in the prior art.

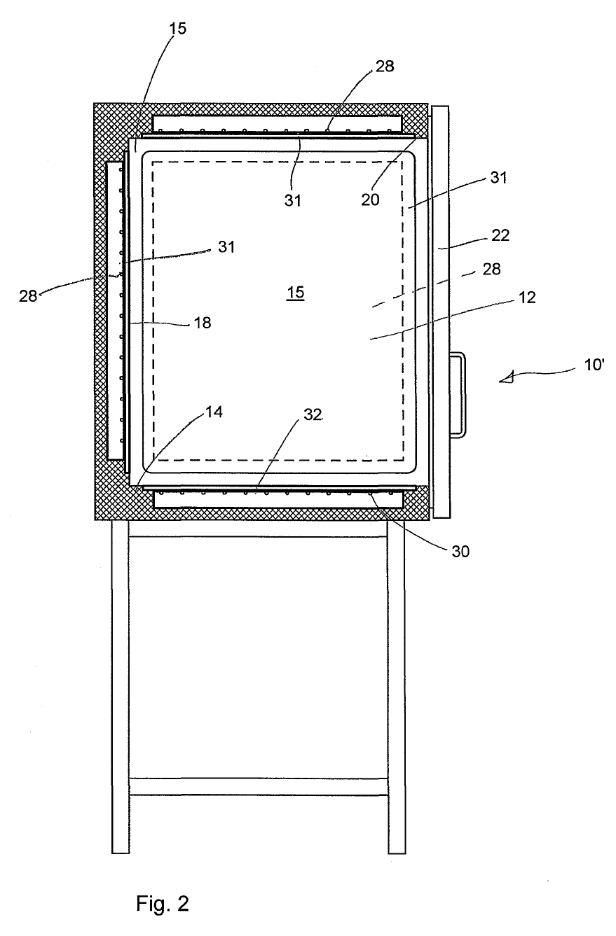

FIG. 2 shows a second embodiment of the combination steamer 10′ of the invention. In the combination steamer 10′, unlike the first embodiment, a heating panel 31 is additionally embedded in the top wall 20 of the cooking chamber. The heating panel 31 in the top wall 20 has the same architecture as the heating panels 31 in the walls 15, 16, and 18 or the cook top 32 in the floor 14. In the combination steamer 10′, the cooking chamber 12 additionally has top heat, which renders superfluous an insertable grill as is usually provided in combination steamers known in the prior art. Furthermore, the heating panel 31 in the top wall 20 allows the cooking chamber to be heated up more uniformly, which is of particular advantage when the combination steamer is operated as an oven. In the combination steamer 10 shown in FIG. 1 and the combination steamer 10′ shown in FIG. 2, the cook top 32 can be designed as an induction grill plate made of a multilayered material capable of induction. The architecture of the multilayered material of this multilayered plate can be the same as that described above. The induction grill plate can in every respect be formed in the manner described in DE 101 20 500 B4 mentioned at the outset.

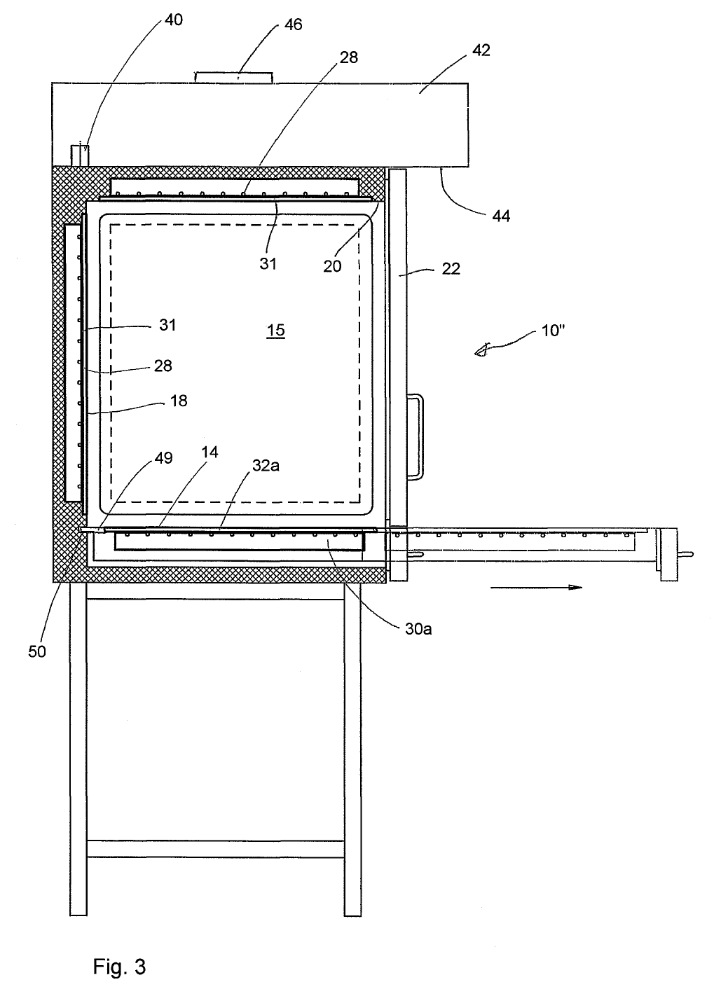

FIG. 3 shows a combination steamer designated as a whole by reference numeral 10″ as a third embodiment of the invention. In the combination steamer 10″, the cook top 32 is designed as one that can be retracted from the cooking chamber 12 in the manner of a drawer, as shown in FIG. 3. FIG. 4 is a front view of the combination steamer 10″, with the door 22 of the cooking chamber 12 not shown for the sake of clarity. In combination steamer 10″ also, the cook top 32 forms the floor and thus forms the bottom delimitation of the cooking chamber 12. The ability of the cook top 32 to be retracted to a position shown in FIG. 3 makes it easier for the user of the combination steamer 10″ to work when the cook top 32 is used as a stove. As in the case of the first two embodiments, the cook top 32 can comprise a plurality of hot plates and the second heater 30 can comprise a plurality of heating means assigned individually to each of the hot plates. In the exemplary embodiment shown in FIGS. 3 and 4, the second heater 30 comprises two heating means 30a and 30b. The floor 14 comprises a recess, which is open towards the front facing the door 22 and into which the cook top 32 can be inserted when it is not intended for operation as a stove outside the cooking chamber 12.

In the combination steamer 10″ shown in FIGS. 3 and 4, the cooking chamber comprises a discharge port for exhaust steam and exhaust air. Furthermore, an exhauster hood, which is connected to the discharge port 40 and is designated as a whole by reference numeral 42, is disposed on top of the combination steamer 10″. The exhauster hood 42 can, as mentioned above, be of the same construction as that disclosed in WO 2007/042307 cited above. Without going into details, an exhauster hood of said construction comprises an exhaust port 44 (visible in FIG. 3) above the door 22, an inlet filter assembly, an associated exhaust fan, a condensation heat exchanger for demoisturizing expelled vapors exhausted by suction from the cooking chamber 12 via the discharge port 40 or taken in via the exhaust port 44, connecting means for the discharge port 40, and an outlet port 46, which preferably leads to the immediate environment of the exhauster hood 42 and which is indicated in FIGS. 3 and 4 as an outlet pipe connector. The exhaust air channel communicates with a by-pass channel leading to the upstream side of the inlet filter assembly and the condensation heat exchanger is contacted by the air stream produced by the exhaust fan. This system ensures that the air discharged from the exhauster hood via the outlet port 46 is at least free from particles, including droplets of fat. The by-pass channel leading to the upstream side of the inlet filter assembly ensures that the exhaust air from the combination steamer 10″ passing into the exhauster hood 42 via the discharge port 40 is free from particles (including droplets of fat) before it reaches the condensation heat exchanger and leaves the exhauster hood 42 via the outlet port 46. The interior of the exhauster hood 42 is thus not contaminated by fat and the environment is not loaded with unwanted particles. A plasma module can be disposed in the suction channel downstream of the inlet filter assembly. The smallest gaseous organic carbon compound molecules, such as, inter alia, odor molecules, can be eliminated in an environmentally friendly manner by the treatment of exhaust air in such a plasma module. This technology at the same time serves to disinfect the air. This type of air purification is known in the published prior art, for example, in DE 103 12 309 A1 or EP 1 249 265 B1. When the cook top 32 is pulled out and operated as a stove, the cooking chamber 12 can be used with the exhauster hood 42 connected thereto, in order to suck off expelled vapors resulting from the cooking process and to recycle the same as purified circulated air into the environment of the combination steamer 10″. The expelled vapors resulting from cooking are additionally sucked into the exhauster hood 42 by way of the exhaust port 44.

If it is desired to intensify the convection flow produced in the cooking chamber in the first and second embodiments of the combination steamer, a fan 26 can optionally be provided behind the side wall 16, behind which the steam generator 24 is also located. The fan 26 communicates with the cooking chamber 12 on its suction and pressure sides via openings 27 and 27a in the side wall 16. The steam generator 24 disposed outside the cooking chamber 12 likewise communicates with the cooking chamber on its steam outlet side.

At least one ferromagnetic layer, the Curie temperature of which can be implemented for temperature control purposes, can be rolled into or onto the metallic multilayered material of the cook top 32 or of each heating panel 31. The Curie temperature may be 260° C., for example. This means that above this temperature, the metallic multilayered material loses its magnetism and is no longer capable of induction. This can be utilized for temperature control, for example, in order to prevent overheating of the cook top 32 or the heating panels 31. A suitable ferromagnetic material is the soft magnetic iron-nickel-chromium-alloy named PHYTHERM 260 supplied by Imphys Alloys of the Arcelor Group. This alloy has been developed for induction cooking.

In the case of a cook top 32 comprising a plate made of metallic multilayered material, the steam generator 24, which is disposed behind the side wall 16 in the exemplary embodiment shown in FIG. 4, could also be replaced by a trough (not shown) in said plate, which trough communicates with a water supply or can be manually filled with water as required.

As in the case of a conventional oven, slide rails are formed on the walls 15, 16, 18, 20 of the cooking chamber 12. Insertable trays carrying the food to be cooked either directly or in cooking receptacles can be placed at a selectable height on said slide rails. These slide rails are not shown in the drawings. Grooves 48 to 50 are indicated in FIGS. 3 and 4 for the cook top capable of being retracted from the cooking chamber 12 in the manner of a drawer and these grooves serve as a guide for the peripheral edge of the cook top 32.

What is claimed is:

1. A combination steamer comprising:
a cooking chamber externally delimited by a floor, walls, and a front door, and having a steam generator;
a first heater disposed at or on at least one of said walls;
a second heater disposed at or on said floor; and
wherein both heaters are disposed outside said cooking chamber and said floor is designed as a cook top provided with said second heater.

2. The combination steamer as defined in claim 1 wherein said cook top can be retracted from said cooking chamber in the manner of a drawer.

3. The combination steamer as defined in claim 1 wherein said cook top is a cook top of glass-ceramics or the like.

4. The combination steamer as defined in claim 1 wherein said cook top comprises a plate of metallic multilayered material.

5. The combination steamer as defined in claim 1 wherein said second heater is a radiant and/or inductive heater.

6. The combination steamer as defined in claim 1 wherein said cook top exhibits a plurality of hot plates and that said second heater comprises a plurality of heating means individually assigned to each of said hot plates.

7. The combination steamer as defined in claim 1 wherein said cooking chamber has a discharge port for exhaust steam and exhaust air.

8. The combination steamer as defined in claim 7 wherein an exhauster hood is disposed on top of said combination steamer and communicates with said discharge port.

9. The combination steamer as defined in claim 1 wherein at least one of said walls is formed as a heating panel provided with a first heater.

10. The combination steamer as defined in claim 9 wherein said heating panel comprises a plate of glass-ceramics or the like or of a metallic multilayered material.

11. The combination steamer as defined in claim 1 wherein said first heater is a radiant and/or inductive heater.

12. The combination steamer as defined in claim 1 wherein a fan is disposed outside said cooking chamber and which communicates, on its suction and pressure sides, with said cooking chamber via openings in one of said walls.

13. The combination steamer as defined in claim 1 wherein said steam generator is disposed outside said cooking chamber and communicates, on its steam outlet side, with said cooking chamber.

14. The combination steamer as defined in claim 4 wherein at least one ferromagnetic layer, the Curie temperature of which can be utilized for temperature control purposes, is rolled into or onto said metallic multilayered material.

15. The combination steamer as defined in claim 10 wherein at least one ferromagnetic layer, the Curie temperature of which can be utilized for temperature control purposes, is rolled into or onto said metallic multilayered material.
